(19) United States
(12) Patent Application Publication
(10) Pub. No.: US 2013/0169569 A1
(43) Pub. Date: Jul. 4, 2013

(54) TOUCH DISPLAY PANEL

(71) Applicant: Au Optronics Corporation, Hsinchu (TW)

(72) Inventor: Li-Wei Shih, Hsinchu County (TW)

(73) Assignee: Au Optronics Corporation, Hsinchu (TW)

(21) Appl. No.: 13/716,200

(22) Filed: Dec. 16, 2012

(30) Foreign Application Priority Data
Dec. 30, 2011 (TW) 100149890

(51) Int. Cl. G06F 3/041

(52) U.S. Cl. CPC G06F 3/041
USPC 345/173

(57) ABSTRACT

A touch display panel includes a first substrate, a pixel array, a second substrate, a display medium layer, a third substrate, a first touch electrode layer, a second touch electrode layer and a polarizer. The first substrate has the pixel array thereon. The second substrate is disposed opposite to the first substrate. The display medium layer is between the first substrate and the second substrate. The third substrate is disposed opposite to the second substrate and has the first touch electrode layer thereon. The second touch electrode layer is disposed between the first touch electrode layer and the second substrate. The polarizer is disposed between the first touch electrode layer and the second touch electrode layer.

### CROSS-REFERENCE TO RELATED APPLICATION

This application claims the priority benefit of Taiwan application serial no. 100149890, filed on Dec. 30, 2011. The entirety of the above-mentioned patent application is hereby incorporated by reference herein and made a part of this specification.

### TECHNICAL FIELD

The invention relates to a touch display panel.

### BACKGROUND

A touch display panel includes a display panel and a touch panel, wherein the touch panel may be constructed internally inside the display panel or adhered externally on the display panel. Currently, the touch panel is basically divided into, according to the touch sensing methods, a resistive touch panel, a capacitive touch panel, an optical touch panel, an acoustic-wave touch panel and an electromagnetic touch panel. Since a capacitive touch panel provides the advantages of fast response time, desired reliability and durability, the capacitive touch panel has been broadly used in electronic products.

As electronic devices trends toward thin volume, a substrate thinning process is typically performed on the display panel or the touch panel. However, the circuits of a conventional touch display panel is exposed outside the substrate of the display panel. These exposed circuits are easily corroded by strong acid during the substrate thinning process to render the touch devices inside the touch display panel inoperable.

### SUMMARY

An exemplary embodiment of the invention provides a touch display panel, in which the problem of easily induced damages on the circuits of the touch display panel during a substrate thinning process of a traditional touch display panel is resolved.

An exemplary embodiment of the invention provides a touch display panel, which includes a first substrate, a pixel array, a second substrate, a display medium layer, a third substrate, a first touch electrode layer, a second touch electrode layer and a polarizer. The first substrate includes the above-mentioned pixel array thereon. The second substrate and the first substrate are disposed opposite to each other. The display medium layer is configured between the first substrate and the second substrate. The third substrate and the second substrate are configured opposite to each other, wherein the third substrate includes the above-mentioned first touch electrode. The second touch electrode layer is configured between the second substrate and the first touch electrode layer. The polarizer is configured between the first touch electrode layer and the second touch electrode layer.

An exemplary embodiment of the invention provides a touch display panel including a first substrate, a pixel array, a second substrate, a display medium layer, a third substrate, a first touch electrode layer, a second touch electrode layer and a polarizer. The first substrate includes the above-mentioned pixel array thereon. The second substrate and the first substrate are disposed opposite to each other. The display medium layer is configured between the first substrate and the second substrate. The third substrate and the second substrate are configured opposite to each other, wherein the third substrate includes the above-mentioned first touch electrode layer. The second touch electrode layer is configured between the second substrate and the display medium layer. The polarizer is configured between the first touch electrode layer and the second substrate.

According to an exemplary embodiment of the invention, the first touch electrode layer is fabricated on the third substrate, and the second touch electrode layer is fabricated at the exterior of the second substrate. Alternatively speaking, after the substrate thinning process is performed on the first substrate and the second substrate, the second touch electrode layer is fabricated on the second substrate. Accordingly, the circuits of the first/second touch electrode layer are prevented from being impaired due to the substrate thinning process.

The invention and certain merits provided by the invention can be better understood by way of the following exemplary embodiments and the accompanying drawings, which are not to be construed as limiting the scope of the invention.

### BRIEF DESCRIPTION OF THE DRAWINGS

FIG. 1 is a schematic, cross-sectional view diagram of a touch display panel according to an exemplary embodiment of the disclosure.

FIG. 2 is a perspective view diagram of the touch display device in FIG. 1.

FIG. 3 is a schematic, cross-sectional view diagram of a touch display panel according to an exemplary embodiment of the disclosure.

FIG. 4 is a schematic, cross-sectional view diagram of a touch display panel according to an exemplary embodiment of the disclosure.

FIG. 5 is a perspective view diagram of the touch display device in FIG. 4.

FIG. 6 is a schematic, cross-sectional view diagram of a touch display panel according to an exemplary embodiment of the disclosure.

FIGS. 7 and 8 are schematic, cross-sectional view diagram of a touch display panel according to various exemplary embodiments of the disclosure.

### DETAILED DESCRIPTION OF DISCLOSED EMBODIMENTS

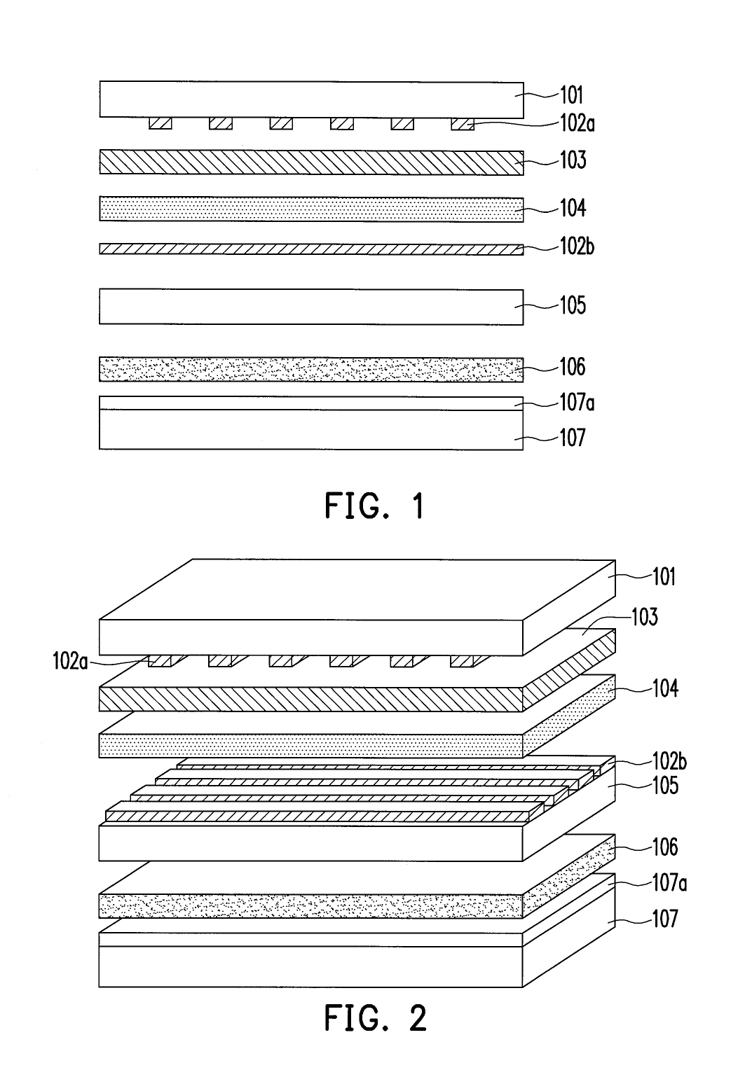

FIG. 1 is a schematic, cross-sectional view diagram of a touch display panel according to an exemplary embodiment of the disclosure. FIG. 2 is a perspective view diagram of the touch display device in FIG. 1. Referring concurring to FIGS. 1 and 2, the touch display panel includes a first substrate 107, a pixel array 107a, a second substrate 105, a display medium layer 106, a third substrate 101, a first touch electrode 102a, a second touch electrode 102b and a polarizer 104. According to this exemplary embodiment of the disclosure, the touch display panel further includes an adhesive material layer 103.

The first substrate 107 includes the above-mentioned pixel arrays 107a. The material of the first substrate 107 includes glass, quartz, organic polymer, or opaque/reflective material (for example, electric conductive material, metal wafer, ceramics, or other appropriate materials), or other appropriate materials.

The pixel array 107a includes a plurality of scan lines, a plurality of data lines and a plurality of pixel structures (not shown) electrically connected with the above scan lines and data lines. According to an exemplary embodiment, each of the above pixel structures includes at least an active device and a pixel electrode connecting with the active device. The design of devices in the above pixel structures in the pixel array is related to type of the display panel. For example, if the touch display panel of this exemplary embodiment is a liquid crystal display panel with a touch function, the pixel structures includes a thin film transistor, a storage capacitor and the pixel electrode connecting with the thin film transistor. If the touch panel of this exemplary embodiment is an organic electroluminescent display panel, the pixel structures includes a switching thin film transistor (TFT), a driving thin film transistor, a storage capacitor, and a pixel electrode (may also be known as cathode or electrode) electrically connecting with the driving thin film transistor.

The second substrate 105 and the first substrate 107 are disposed opposite to each other. According to this exemplary embodiment, the material of the second substrate 107 includes glass, quartz, organic polymer, or other suitable materials. Herein, the first substrate 107 is, for example, a transparent substrate or an opaque substrate, while the second substrate 105 is a transparent substrate, or the first substrate 107 and the second substrate 105 are both transparent substrates.

The display medium layer 106 is configured between the first substrate 107 and the second substrate 105. The display medium layer 106 includes a liquid crystal medium, an organic electroluminescent display medium, an electrophoretic display medium, an electrowetting display medium, or other appropriate display medium. The display medium layer 106 and the second substrate 105 may further include an electrode layer (not shown) and/or a color filter layer (not shown), or components that are related to a display panel. For example, if the touch display panel of this exemplary embodiment is a liquid crystal display panel having a touch function, the display medium layer 106 and the second substrate 105 may further includes an electrode layer and a color filter layer. If the touch display panel of this exemplary embodiment is a electroluminescent display panel having a touch function, the display medium layer 106 and the second substrate 105 may further includes an electrode layer (may also be known as a cathode or an anode) disposed therebetween. Further, the second substrate 105 disposed on the display medium 106 serves as a protection plate of the display medium 106.

The third substrate 101 and the second substrate 105 are disposed opposite to each other, wherein the third substrate 101 includes the above-mentioned first touch electrode layer 102a thereon. According to this exemplary embodiment, the material of the third substrate 101 includes, for example, glass, quartz, organic polymer or other appropriate materials. The third substrate 101 may also be known as a cover lens.

The second touch electrode 102b is configured between the second substrate 105 and the first touch electrode 102a. The first touch electrode layer 102a disposed on the third substrate 101 and the second touch electrode layer 102b configured between the first touch electrode layer 102a and the second substrate 105 include a Y-direction touch series and an X-direction touch series, respectively. For example, as shown in FIG. 2, the touch electrode layer 102a on the third substrate 101 includes a plurality of touch electrode patterns extending in the Y-direction, and the second touch electrode layer 102b configured between the second substrate 105 and the first touch electrode layer 102a includes a plurality of touch electrode patterns extending in the X-direction. According to the designs of the first touch electrode layer 102a and the second touch electrode layer 102b, the touch position of the user can be determined.

It is worthy to point out that the first touch electrode layer 102a and the second touch electrode layer 102b of the invention is not limited to the electrode patterns as shown in FIG. 2. According to other exemplary embodiments, the electrode patterns of the first touch electrode layer 102a and the second touch electrode layer 102b may include other patterns.

The polarizer 104 is positioned between the first touch electrode layer 102a and the second touch electrode layer 102b. If the touch display panel of this exemplary embodiment includes a liquid crystal display panel with a touch function, the polarizer 104 is used to coordinate with the liquid crystal medium 106 to achieve the display of an image. If the touch display panel of this exemplary embodiment includes an electroluminescent display panel with a touch function, the polarizer 104 serves as an anti-reflective film to improve display quality of the display.

The adhesive material layer 103 is disposed between the first touch electrode layer 102a and the polarizer 104, and the first touch electrode layer 102a and the polarizer 104 are adhered together via the adhesive material layer 103. In this exemplary embodiment, the adhesive material layer 103 may include an optical adhesive material, and the adhesive material layer 103 globally covers the first touch electrode layer 102a or the polarizer 104. More specifically, the adhesive material layer 103 globally covers the first touch electrode layer 102a or the polarizer 104. Hence, the optical transparency of a material is normally being considered for the selection of the material of the adhesive layer 103.

According to the above disclosure of the exemplary embodiment, the first touch electrode layer 102a is formed on the surface of the third substrate 101 and the second touch electrode layer 102b is disposed on the surface of the second substrate 105. Accordingly, a thinning process is first performed on the first substrate 107 and the second substrate 105, followed by forming the second touch electrode layer 102b on the second substrate 105, and further followed by assembling the third substrate 101 with the first touch electrode layer 102a and the second substrate 105 with the second touch electrode layer 102b to form the touch display panel. Alternatively speaking, forming the second electrode layer 102b after the thinning of the first substrate 107 and the second substrate 105 and forming the first touch electrode layer 102a directly on the third substrate 101 according to the exemplary embodiment, the first touch electrode layer 102a and the second touch electrode layer 102b are obviated from being damaged in the substrate thinning process, while the thinning of a touch display panel is achieved.

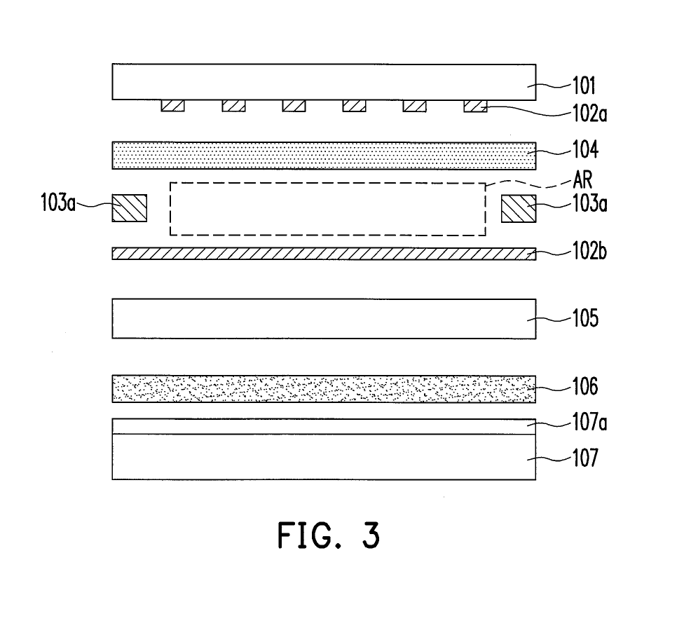

FIG. 3 is a cross-sectional view diagram of a touch display panel according to an exemplary embodiment of the invention. The exemplary embodiment of FIG. 3 is similar to the exemplary embodiment of FIG. 1. Whenever possible, the same reference numbers are used FIG. 1 and FIG. 3 to refer to the same or like parts. The difference between this exemplary embodiment and the first exemplary embodiment lies in that the adhesive material layer 103a is disposed between polarizer 104 and the second touch electrode layer 102b. More specifically, the adhesive material layer 103a is disposed at a border region between the polarizer 104 and the second electrode layer 102b. In other words, the adhesive material layer 103a does not globally cover the polarizer 104 or the second touch electrode layer 102b. In this exemplary embodiment, the adhesive material layer 103a has a frame pattern, encircling the border region of the polarizer 104 or the second touch electrode layer 102b, exposing the central region of the polarizer 104 or the second touch electrode layer 102b. Herein, the border region corresponds to the non-display region of the above touch display panel, while the central region corresponds to the display region of the above-mentioned touch display panel.

According to the above disclosure, the adhesive material layer 103a is disposed at the border region between the polarizer 104 and the second touch electrode layer 102b. Hence, an air gap AR is present between the adhesive layer 103a, the polarizer 104 and the second touch electrode layer 102b. Alternatively speaking, the adhesive material layer 103a encircles the border region (non-display region) of the polarizer 104 or the second touch electrode layer 102b, and the internal air gap of the adhesive material layer 103a corresponds to the central region (display region). Since the adhesive material layer 103a of this exemplary embodiment encircles the border region (non-display region) of the polarizer 104 or the second touch electrode layer 102b, the adhesive layer 103a may be selected from the non-optical adhesive materials to lower the cost of adhesive materials.

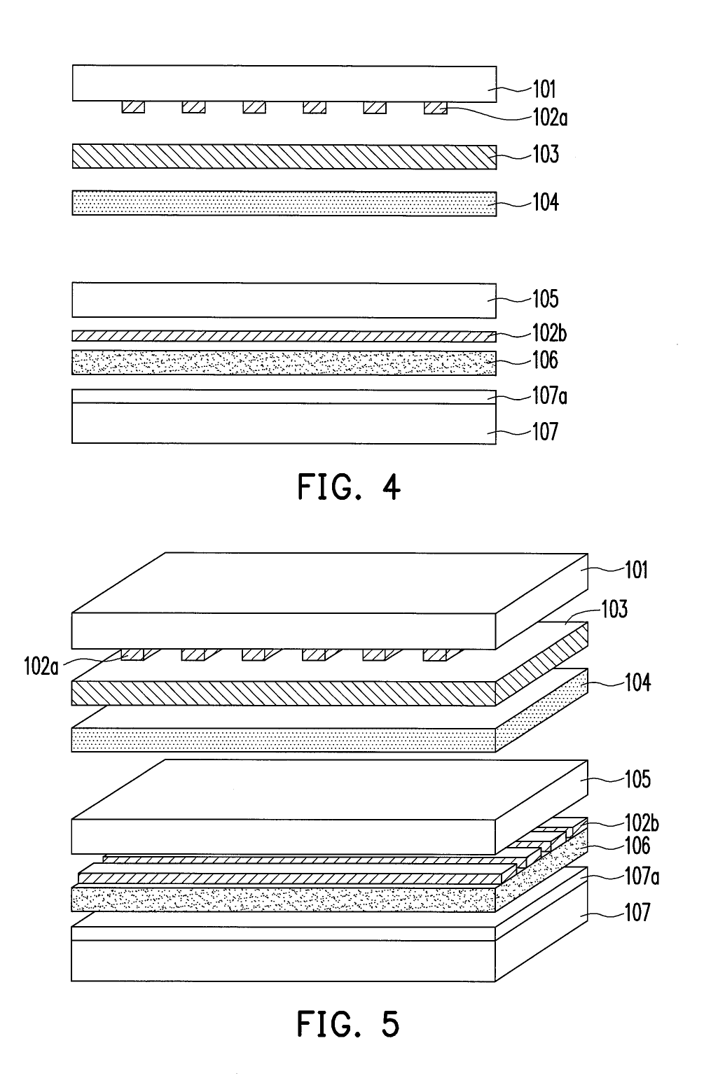

FIG. 4 is a cross-sectional diagram of a touch display panel according to an exemplary embodiment of the invention. FIG. 5 is a perspective view diagram of the touch display panel in FIG. 4. Referring to both FIGS. 4 and 5, this exemplary embodiment and the exemplary embodiment in the above FIGS. 1 and 2 are similar; hence, the same reference numbers are used to refer to the same or like parts in FIGS. 1, 2, 4 and 5. In the current exemplary embodiment, the second touch electrode layer 102b is located between the second substrate 105 and the display medium layer 106, while the polarizer 104 is located between the first touch electrode layer 102a and the second substrate 105.

In this exemplary embodiment, the first electrode layer 102a is formed on the surface of the third substrate 101 and the second electrode layer 102b is disposed between the second substrate 105 and the display medium layer 106. Hence, in this exemplary embodiment, the second touch electrode layer 102b is first formed between the first substrate 107 and the second substrate 105, followed by performing a thinning process on the first substrate 107 and the second substrate 105. Therefore, the second touch electrode layer 102b is prevented from being damaged by the substrate thinning process because the second touch electrode layer 102b is sealed between the first substrate 107 and the second substrate 105. Thereafter, a touch display panel is constructed with the third substrate 101 already formed with the first touch electrode layer 102a and the second substrate 105. In this exemplary embodiment, the first touch electrode layer 102a and the second touch electrode layer 102b are prevented from being damaged by the substrate thinning process to achieve the touch display panel thinning effect.

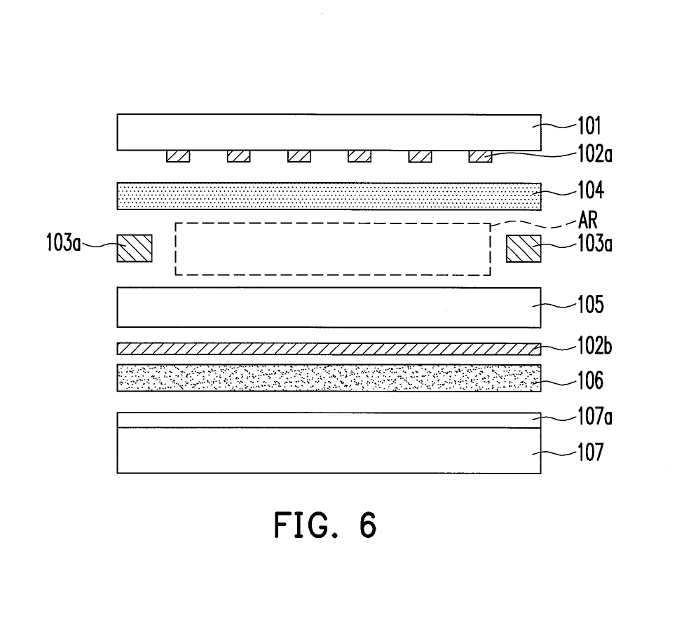

FIG. 6 is a cross-sectional diagram of a touch display panel according to an exemplary embodiment of the invention. The exemplary embodiment of FIG. 6 and the exemplary embodiment of FIG. 4 are similar; hence, the same reference numbers are used to refer to the same or like parts in FIGS. 4 and 6. In this exemplary embodiment, the adhesive material layer 103a is configured between the polarizer 104 and the second substrate 105. More specifically, the adhesive material layer 103a is configured at the border region between the polarizer 104 and the second substrate 105. Alternatively speaking, the adhesive layer 103a does not globally cover the polarizer 104 or the second substrate 105. In this exemplary embodiment, the adhesive layer 103a has a frame pattern, surrounding the border region of the polarizer 104 or the second substrate 105 and exposing the central region of the polarizer 104 or the second substrate 105. Herein, the border region corresponds to the non-display region of the touch display panel, while the central region corresponds to the display region of the touch display panel.

Accordingly to this exemplary embodiment of the invention, the adhesive material layer 103a is disposed at the border region between the polarizer 104 and the second substrate 105. The adhesive material layer 103a, the polarizer 104 and the second substrate 105 have an air gap there-between. In other words, the adhesive material layer 103a encircles the border region (non-display region) of the polarizer 104 or the second substrate 105. Since the adhesive material layer 103a of this exemplary embodiment encircles the border region (non-display region) of the polarizer 104 or the second substrate 105, the adhesive material layer 103a may be selected from the non-optical type of adhesive materials to lower the cost.

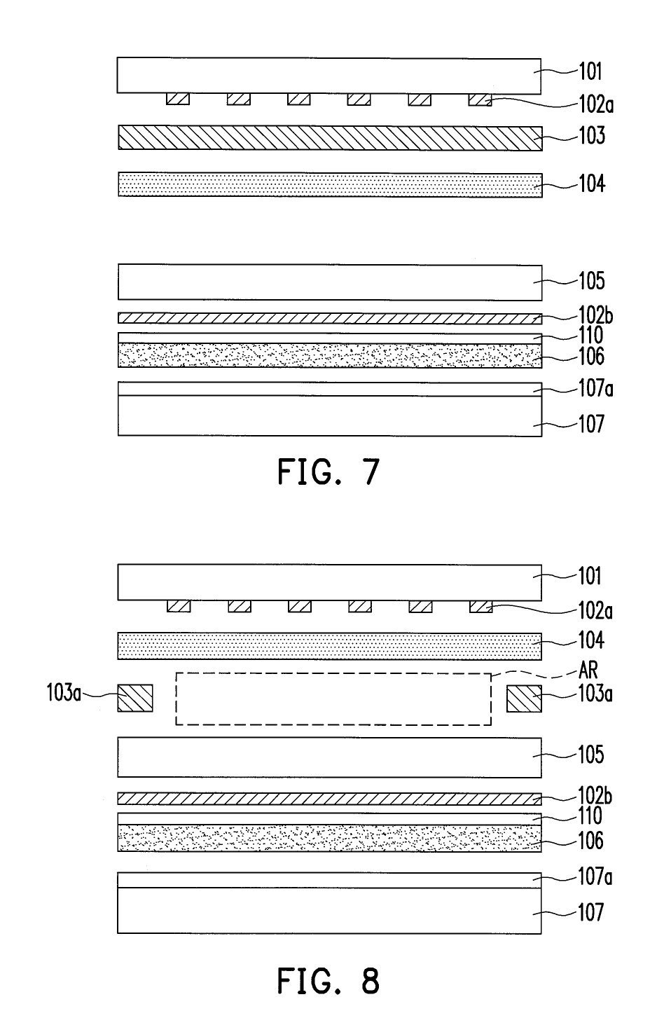

FIG. 7 is a cross-sectional view diagram of a touch display panel of several exemplary embodiments of the invention. The exemplary embodiments of FIG. 7 and the exemplary embodiment of FIG. 4 are similar; hence, the same reference numbers are used to refer to the same or like parts in FIGS. 4 and 7. The difference between two exemplary embodiments lie in that the touch display panel further includes planarization layer 110, wherein the planarization layer 110 is configured between the second touch electrode layer 102b and the display medium 106. Generally speaking, if the touch display panel is an organic electroluminescent display panel with a touch function, its surface is a non-planarized surface due to the relationship between the pixel array 107a (thin film transistor circuit layer) and the display medium (the organic electroluminescent layer). Hence, this exemplary embodiment, a planarization layer 110 is disposed between the second touch electrode layer 102b and the display medium 106, and the second touch electrode layer 102b is disposed on the surface of the flat planarization layer 110, which also serves as an insulation between the circuits of the second touch electrode layer 102b.

FIG. 8 is a cross-sectional view diagram of a touch display panel according to several exemplary embodiments of the invention. The exemplary embodiments of FIG. 8 and the exemplary embodiment of FIG. 6 are similar; hence, the same reference numbers are used to refer to the same or like parts in FIGS. 8 and 6. The difference between this exemplary embodiment and the embodiment of Figure lies in that the touch display panel further includes a planarization layer 110, wherein the planarization layer 110 is configured between the second touch electrode layer 102b and the display medium layer 106. Generally speaking, if the touch display panel is an organic electroluminescent display panel with a touch function, the relationship between the pixel array 107a (thin film transistor circuit layer) and the display medium layer 106 (organic electroluminescent layer) pattern provides a non-planarized surface. Therefore, in this exemplary embodiment, the second touch electrode layer 102b and the display medium 106 are disposed with a planarization layer 110 therebetween. The second touch electrode layer 102b is formed with a flat planarized layer 110 on the surface thereof, and the flat planarized layer 110 may also serve as an insulation between the circuits of the second touch electrode layer 102b.

According to the exemplary embodiment, the first touch electrode layer is fabricated on the third substrate according to an exemplary embodiment of the invention, and the second touch electrode layer is fabricated at the exterior of second substrate. In other words, a substrate thinning process is performed on the first substrate and the second substrate, followed by the fabrication of the second touch electrode layer on the second substrate. The circuits of the first/second touch electrode layer are prevented from being impaired by the substrate thinning process.

Further, according to another exemplary embodiment, the first touch electrode layer is fabricated on the third substrate, and the second touch electrode layer is fabricated between the first substrate and the second substrate. Since the second touch electrode layer is fabricated between the first substrate and the second substrate, the thinning process performed on the first substrate and the second substrate will not induce any damage on the second touch electrode layer. After the substrate thinning process, the third substrate having the first touch electrode layer and second substrate are then assembled together, the circuits of the first/second touch electrode layer are not impaired by the substrate thinning process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display panel, comprising:
a first substrate, comprising a pixel array thereon;
a second substrate, configured opposite to the first substrate;
a display medium layer, configured between the first substrate and the second substrate;
a third substrate, configured opposite to the second substrate, and the third substrate comprising a first touch electrode layer thereon;
a second touch electrode layer, configured between the second substrate and the first touch electrode layer;
a polarizer, configured between the first touch electrode layer and the second touch electrode layer.

2. The touch display panel of claim 1 further comprising an adhesive material layer, configured between the first touch electrode layer and the polarizer.

3. The touch display panel of claim 2, wherein the adhesive material layer comprises an optical adhesive material globally covering the first touch electrode layer or the polarizer.

4. The touch display panel of claim 1 further comprising an adhesive material layer configured between the polarizer and the second touch electrode layer.

5. The touch display panel of claim 4, wherein the adhesive material layer is disposed at a border region between the polarizer and the second touch electrode layer.

6. The touch display panel of claim 5, wherein the adhesive material layer, the polarizer and the second touch electrode layer comprises an air gap therebetween.

7. A touch display panel, comprising:
a first substrate, comprising a pixel array thereon;
a second substrate, configured opposite to the first substrate;
a display medium layer, configured between the first substrate and the second substrate;
a third substrate, configured opposite to the second substrate, and the third substrate comprising a first touch electrode layer thereon;
a second touch electrode layer, configured between the second substrate and the display medium layer;
a polarizer, configured between the first touch electrode layer and the second substrate.

8. The touch display panel of claim 7 further comprising an adhesive material layer, configured between the first touch electrode layer and the polarizer.

9. The touch display panel of claim 8, wherein the adhesive material layer comprises an optical adhesive material globally covering the first touch electrode layer or the polarizer.

10. The touch display panel of claim 7 further comprising an adhesive material layer configured between the polarizer and the second substrate.

11. The touch display panel of claim 10, wherein the adhesive material layer is disposed at a border region between the polarizer and the second substrate.

12. The touch display panel of claim 11, wherein the adhesive material layer, the polarizer and the second substrate comprises an air gap therebetween.

13. The touch display panel of claim 8 further comprising a planarization layer, wherein the planarization layer is configured between the second touch electrode layer and the display medium.

14. The touch display panel of claim 10 further comprising a planarization layer, wherein the planarization layer is configured between the second touch electrode layer and the display medium.
